(19) United States
(12) Patent Application Publication
(10) Pub. No.: US 2006/0211438 A1
(43) Pub. Date: Sep. 21, 2006

(54) Method and system for granting floor in push-to-talk over cellular network

(75) Inventors: Sang-Kyung Sung, Seoul (KR); Sung-Jin Park, Suwon-si (KR); Joon-Goo Park, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/359,628

(22) Filed: Feb. 22, 2006

(30) Foreign Application Priority Data
Feb. 23, 2005 (KR) 2005-15144

(51) Int. Cl. H04B 7/00

(52) U.S. Cl. 455/518

(57) ABSTRACT

Provided is a method and system for granting the floor in a PoC network, in which, when a PoC server makes a request to establish a PoC session according to preset information of a PoC client wishing to make a PoC call rather than a session invitation request of the PoC client, an INVITE message is sent to the PoC client, including content related to grant of the session's initial talk turn, thereby lessening the signaling burden of a talk burst control protocol message. The method includes sending an INVITE message to a terminating PoC client when it is determined that session initiation requirements are met, and sending the INVITE message to an originating PoC client when a response signal to the INVITE message is received from the terminating PoC client.

This application makes reference to and claims all benefits accruing under 35 U.S.C. §119 from an application for METHOD AND SYSTEM FOR GRANTING FLOOR IN PUSH-TO-TALK OVER CELLULAR NETWORK filed in the Korean Intellectual Property Office on Feb. 23, 2005 and duly assigned Serial No. 2005-15144, the contents of which are incorporated herein by reference.

### BACKGROUND OF THE INVENTION

1. Field of the Invention

The present invention relates to a method for efficiently establishing a session capable of making a push-to-talk-over-cellular (PoC) call through a network, and more particularly to a method and system for granting the floor to an originating PoC client using Session Initiation Protocol (SIP) communication when a home PoC server of interest establishes a session by setup of the originating PoC client.

2. Description of the Related Art

Significant developments in mobile communication technology and the extension of mobile communication networks have resulted in the development of a vast array of additional services and applications for use with a cellular phone. Concurrently, there is an increasing demand from cellular phone users for additional services, such as a location, multimedia and push-to-talk (PTT) service. Among these extra services, the PTT service supports various supplementary functions such as instant messenger and a status display, as well as a group call and a voice call which are also provided by an existing radio or a trunk radio system (TRS).

Standardization of a push-to-talk-over-cellular (PoC) service that employs the PTT function in a mobile communication network is currently taking place. One unique-feature of the PoC service is that a user can participate in a plurality of PoC sessions and thus can use a call service while moving among the PoC sessions as desired. This feature is a requirement that is specified in the open mobile alliance (OMA), which is a forum for specifying mobile communications services.

FIG. 1 is a schematic diagram illustrating a conventional PoC service system. Referring to FIG. 1, a PoC client 10, as a service requester installed in a mobile station, is generally connected to a Session Initiation Protocol/Internet Protocol (SIP/IP) core network 30 that supports SIP and IP multimedia functions via an access network 20.

The PoC client 10 resides in a PoC user terminal to provide access to the PoC service. The PoC client 10 mainly serves to establish, participate in and terminate a PoC session. In addition, the PoC client 10 acts to make and transfer a talk burst, support an instant personal alert and authenticate when accessing the PoC service. Hereinafter, unless otherwise stated, the PoC client 10 is assumed to be the same as a PoC service subscriber.

The SIP/EP core network 30 is connected to a PoC server 60, a Group List and Management System (GLMS) 50 and a presence server 70 in order to support the PoC service.

Generally, SIP is a standard defined in Internet Engineering Task Force (IETF) Request for Comments (RFC) 2543. SIP is an application-layer control protocol that is used to set up, modify and terminate a session or call for multimedia communication such as video and voice communication. SIP exists over a User Datagram Protocol (UDP)/TCP/IP layer, which supports both unicast and multicast sessions in order to initiate a session by inviting participants to a multimedia conference with a client/server protocol capable of exchanging SIP Request and Response messages.

The SIP Request message provides the following six functions in RFC 2543: INVITE (Invitation to participate in a session), ACK (Acceptance of an INVITE request), BYE (Termination of a call), REGISTER (Registration with a redirect server by a user agent), CANCEL (Cancellation of a pending request) and OPTIONS. The SIP Response message provides the following status codes: 1xx (Information response), 2xx (Success response), 3xx (Redirection response), 4xx (Client Error, Request Failure), 5xx (Server Error) and 6xx (Global Failure).

The GLMS 50, which stores information of the PoC service subscribers, serves to transmit the information of each of the PoC service subscribers (e.g., ID, terminal number, group information of the subscriber) in cooperation with the PoC server.

The presence server 70, which stores state information such as an on-line or off-line state and location of each PoC service subscriber, makes it possible to immediately use communication services by registering/maintaining the current location of an on-line user, and providing other users with this information.

At this time, the PoC server 60 serves as a Controlling PoC Function (CF) for maintaining and managing a PoC session, or a Participating PoC Function (PF) for participating in a PoC session for a one-to-one PoC call or a one-to-many PoC call (or group PoC call).

The PoC server is classified into a CF of taking charge of overall maintenance and management of a PoC session and a PF of taking charge of maintenance and management between each PoC session, which will be explained below with reference to relevant tables.

TABLE 1
Controlling PoC Function (CF)

Provides centralized PoC session handling
Provides centralized Media distribution
Provides centralized Talk Burst Arbitration functionality including talker
identification
Provides SIP session handling, such as SIP session origination and
termination
Provides policy enforcement for participation in group sessions
Provides participant information
Collects and provides centralized media quality information
Provides centralized charging reports
May provide transcoding between different codecs
Supports Talk Burst Control Protocol Negotiation

As shown in Table 1, the CF serves to maintain and manage an entire PoC session. The PoC server receives requests the floor from PoC clients, arranges an order in which to give the clients the floor, and gives the clients the floor in that order. The PoC server also distributes a talk burst, for which an arbitrary PoC client makes a request, to all other PoC clients participating in a group PoC call, and provides information of the PoC clients participating in the group PoC call.

As shown in Table 2 below, the PF manages a PoC session between the CF and each PoC client. Particularly, the PF acts to relay the floor between the PoC client and the CF when the PoC client makes a request for the floor or when the CF gives the floor to the PoC client. In addition, the PF serves to relay media between the CF and the PoC client, perform transcoding between different codes, and filter one of two concurrent PoC sessions according to the choice of a PoC user when there is simultaneous talking in the two concurrent PoC sessions.

TABLE 2
Participating PoC Function (PF)

Provides PoC session handling/May provide the Media relay function between PoC client and
Controlling PoC server/May provide user media adaptation procedures/May provide the Talk
Burst control message relay function between PoC client and Controlling PoC server/Provides
SIP session handling, such as SIP session origination, termination, etc., on behalf of the
represented PoC client/Provides policy enforcement for incoming PoC session (e.g. access
control, incoming PoC session barring, availability status, etc.)/May collect and provide media
quality information/Provides the participant charging reports/May provide filtering of the media
streams in the case of simultaneous sessions/May provide transcoding between different codecs/
May support Talk Burst Control Protocol Negotiation/Stores the current Answer Mode and
Incoming PoC Session Barring preferences of the PoC client

In the PoC service system as described above, the PoC user can input information on a group and its members to the GLMS 50 through his/her PoC terminal, and can find out information about PoC users who can be called through an individual or group list transmitted from the GLMS 50. Alternatively, the information on the group and its members may be input, modified and managed in the GLMS via a reliable communication network such as the Internet or an Intranet.

In order to make use of the PoC service, the PoC user registers his/her PoC address with the SIP/IP core network. The SIP/IP core network stores PoC user information at the request of the PoC user. Thus, when another PoC user tries to request a group PoC call, the PoC user registers his/her information in the SIP/IP core network in advance as described above, and requests the group PoC call to his/her SIP/IP core network by using group identification information transmitted from the GLMS. At this time, the SIP/IP core network performs address and domain location determination by using information of the call requesting PoC user, and transfers a PoC call request to a home PoC server with which the call requesting PoC user is registered. In regards to the PoC call request, the PoC server prepares to establish a PoC session, obtains each user's information from the GLMS and transfers a PoC call request signal to a corresponding SIP/IP core network. Here, in the case of a PoC call request to users within an Intradomain, the PoC server performs both the CF and PF. The PoC server, which manages a call-requested PoC user, requests a PoC call to the PoC user after the SIP/IP core network performs the location determination procedure, by using information of the PoC user that is transmitted to the PoC server.

The PoC system is divided into an on-demand session mode and a pre-established (or early) session mode, according to the connection set-up with a PoC server within a user's home network.

In the pre-established session mode, the PoC user sets up a specified session between the PoC client and the PoC server within his/her home network in advance by his/her request. The pre-established session enables the PoC user to negotiate media parameters to be used with the PoC server in advance, and thus perform rapid call setup without renegotiating the media parameters for future use between the server and the client. In order to establish the early session, the PoC client provides media parameters supported to a Session Description Protocol (SDP) body through a method of SIP INVITE, and responds to media parameters provided from the server. The PoC client returns identification information of the newly established early session for a response message to the PoC user including a conference Uniform Resource Identifier (URI). When using the early session, it is possible to preset such features as an IP address, a port number, a code to be used and a talk burst control protocol.

The on-demand session mode refers to a state in which the PoC user does not set up the early session, and wherein the PoC user performs a PoC call connecting procedure after receiving an INVITE message of another PoC user.

Meanwhile, the PoC system makes a half-duplex group PoC call possible, including the above-mentioned features. This multilateral conferencing function is an exemplary feature of the PoC system, and may be divided into an ad hoc PoC group, a pre-arranged PoC group, and a chat PoC group according to the feature that is pre-set.

In the PoC system having the foregoing features, the respective elements such as the PoC client, PoC server, SIP/IP core network, group list server and presence server, as well as procedures of initiating and connecting an initial PoC session through signaling between these elements can be found from the OMA standard draft as the conventional SIP-based technology. Accordingly, their description will be omitted.

An extended PoC standard is being drafted in the OMA standardization group on the basis of the above-mentioned fundamental principle of the PoC system. The present invention is directed to technology in which a network server acts as an initiator of a PoC group session upon a particular request of the PoC client.

Prior to the extended PoC standard, the PoC client mainly acts as an initiator to initiate the PoC group session.

Hereinafter, a conventional method for establishing a session when a network is initiated will be described.

FIG. 2 shows a conventional method of setting up session establishment parameters from a PoC client when a network-initiated PoC session considered as extended PoC service is set up. Schematically, a PoC client registers its desired time, presence information of its opposite client, etc. as potential events in advance, and a PoC server initiates a session when the corresponding event occurs.

Referring to FIG. 2, a PoC client that wishes a PoC call makes a request to a PoC server of its home PoC network for service for establishment of a PoC session using a SIP PUBLISH method. At this time, a SIP message delivered in the PUBLISH method includes an Event header. The Event header has a value in its own field indicating that the request to establish the PoC session is made by the PoC server. Further, with respect to the Event header field value, types of detailed contents (e.g. a time when the PoC client desires to establish the PoC session, and presence information at that time) of a PUBLISH message is set up through a Content-Type header in the SIP message. For example, when the Event header field value is set up as the session establishment time, the Content-Type is set up as a text/plain value or application/xml value. At this time, a Content message of interest can be set up in the fashion of YYYY-MM-DD-HH-SS, which indicates the year, month and day, hours and seconds.

The SIP PUBLISH message generated from the PoC client is sent through a corresponding Participating PoC server to a Controlling PoC server (S101 and S102). At this time, an address of the corresponding PoC server which the PoC client includes in the PUBLISH message is used in Requesta Uniform Resource Identifier (Request-URI), and the PUBLISH message is sent to the corresponding PoC server through a SIP/IP core network using this address information. Meanwhile, when a request is made for an ad hoc group PoC call or establishment of the PoC session with respect to a single PoC client, the Participating PoC server of the PoC client A serves as both the PF and CF.

The PoC server that receives the PUBLISH message for establishing the PoC session from the PoC client confirms acceptance of the request, and responds with a SIP 200 OK message (S103 and S104).

Meanwhile, the PoC client A can make a request for a SIP SUBSCRIBE message to the PoC server in order to check a PoC setting of the PoC client A or whether another event occurs (S105 and S106), and receives the SIP 200 OK message in response to the request (S107 and S108). With respect to the SUBSCRIBE request, the PoC server makes a request for a SIP NOTIFY message containing an event content in order to update the occurred event (S109 and S110), and receives the SIP 200 OK message in response to the request (S111 and S112). Finally, the PoC server receiving the PUBLISH message begins to establish the PoC session when the event occurs according to the Event header and content.

FIGS. 3 and 4 are flowcharts showing a procedure of establishing a PoC session from a PoC server when a network-initiated PoC session is set up. FIGS. 3 and 4 are divided according to which PoC client receives a request for session connection for a PoC call.

Referring to FIG. 3, after receiving a request to establish a PoC session, the CF X of a PoC server which manages an overall system sends a SIP INVITE message to a corresponding PoC client A (S201 and S202), and receives a 200 OK response message, depending on the approval of a PoC user (S203 and S204).

At this time, the PoC client A corresponds either to a user who makes a request for a PoC group session or a specific user. Next, after receiving the 200 OK message from the PoC client A, the CF X sends the INVITE message to another client in the PoC group using the corresponding address information (S205 and S206), and receives a 200 OK message in return according to a response of each PoC user (S207 and S208).

After receiving an initial 200 OK message, the CF X gives the Floor Granted signal of a talk burst control protocol to the PoC client A using an RTCP (Real-time Transport Control Protocol) (S209 and S210). In addition, the CF X sends a Floor Taken signal of the talk burst control protocol, which informs that the floor is granted to another user, to a PoC client B that responds to the INIVITE request (S211 and S212).

Finally, the PoC client A, to which the floor is granted, transmits a media signal such as voice, and the PoC server buffers and forwards a transmitted media stream and transmits it to the corresponding PoC client B.

Meanwhile, it should be noted that the number of terminating PoC clients that request the INVITE message in FIG. 3 may be two or more.

FIG. 4 is similar to FIG. 3 in that the PoC session is requested, but differs from FIG. 3 in that a CF X first makes a request for establishment of the PoC session to a terminating PoC client to which a request for a PoC call is made. Accordingly, after receiving a request for establishment of the PoC session, a CF X sends a SIP INVITE message to a terminating PoC client B (S301 and S302), and receives a response as a 200 OK message, according to approval of a PoC user (S303 and S304). At this time, the PoC client B corresponds to an entity to which a PoC group session is requested by a PoC client A. Then, after receiving the 200 OK message from the PoC client B, the CF X sends the INVITE message for SIP session connection to a client who so requests at the beginning (S305 and S306), and receives a 200 OK message according to a response to the PoC user (S307 and S308).

After receiving the 200 OK message, the CF X gives the Floor Granted signal of a talk burst control protocol to the PoC client A requesting the session using an RTCP (S309 and S310), and sends a Floor Taken signal of the talk burst control protocol, which informs that the floor is granted to another user, to the responding PoC client B (S311 and S312). Finally, the PoC client A that is granted the floor, transmits a media signal such as voice, and the PoC server buffers and forwards a transmitted media stream, and transmits it to the corresponding PoC client B.

In this manner, the conventional method of setting up the network-initiated PoC session exhibits the method of connecting the SIP session from the CF X of the PoC server to the corresponding PoC client. However, after waiting for the 200 OK message of the PoC user to be received in response to the session INVITE message, the CF sends the talk burst control protocol message informing that the media can be sent through the connection. As a result, the time to establish the session is delayed.

This delay occurs because the SIP is utilized only as the communication protocol for the session connection. Meanwhile, when the established PoC group session is an ad hoc group session, there is a need for a group session identifier and its signaling technique, wherein the group session identifier is capable of inherently discriminating the connected session similar to when another user is invited to the ad hoc group session.

### SUMMARY OF THE INVENTION

It is an objective of the present invention to provide a method and system for granting the floor in a PoC network, in which, when a PoC server makes a request to establish a PoC session according to preset information of a PoC client wishing to make a PoC call rather than a session invitation request of the PoC client, an INVITE message is sent to the PoC client, including content related to an initial grant of the floor, thereby lessening the signaling burden of a talk burst control protocol message. According to the present invention, a method for granting the floor in a PoC network includes requesting, by an originating PoC client, a session management server to set up a session including content related to session initiation requirements, determining, by the session management server, whether the session initiation requirements are met, and sending, by the session management server, an INVITE message including content related to grant of the floor when the session initiation requirements are met.

According to the present invention, a PoC system includes an originating PoC client, a terminating PoC client, and a session management server for receiving a session setup request including content related to session initiation requirements from the originating PoC client, determining whether the session initiation requirements are met or not, and sending an INVITE message including content related to the grant of the floor when the session initiation requirements are met.

According to still another aspect of the present invention, a method for granting the floor to a PoC client includes sending session setup request information including content related to session initiation requirements, and receiving an INVITE message including content related to grant of the floor from a session management server.

According to the present invention, a method for granting the floor to a PoC client includes sending session setup request information including content related to session initiation requirements, and receiving an INVITE message including content related to the grant of the floor from a session management server.

### BRIEF DESCRIPTION OF THE DRAWINGS

The above and other objects, features and advantages of the present invention will be more clearly understood from the following detailed description, taken in conjunction with the accompanying drawings, wherein:

FIG. 1 is a schematic diagram illustrating a conventional PoC service system;

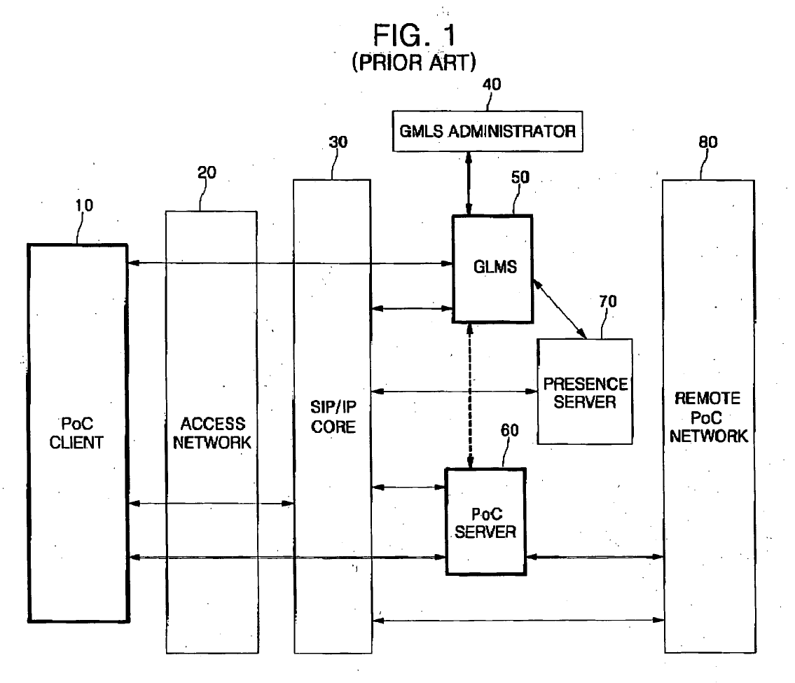

FIG. 2 is a flowchart showing a conventional method of setting up service parameters from a PoC client when a network-initiated PoC session is set up;

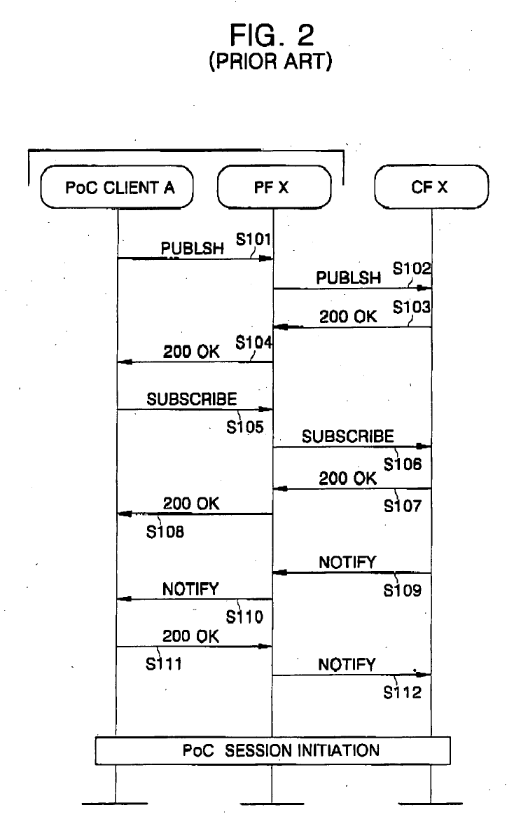

FIG. 3 shows a first embodiment for setting up a network-initiated PoC session;

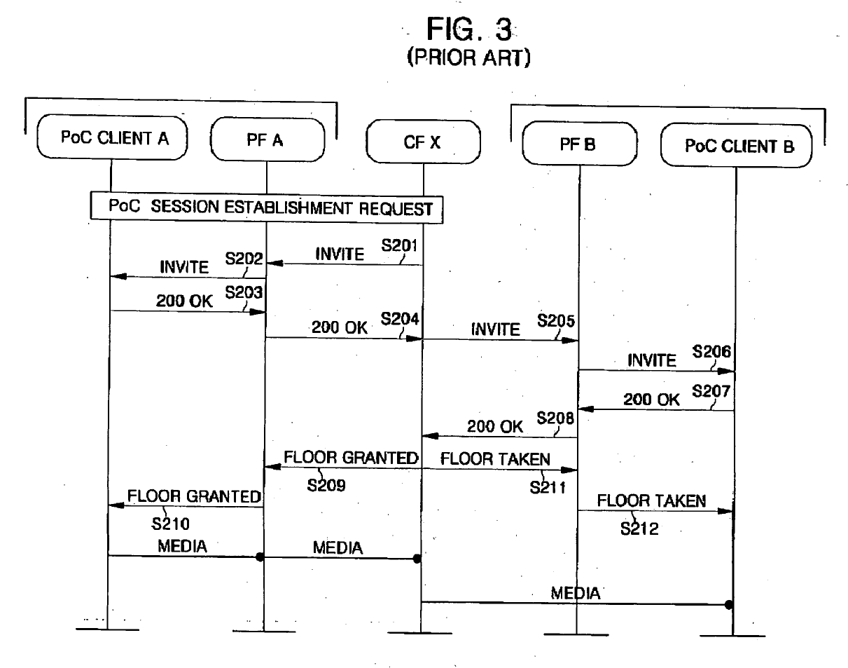

FIG. 4 shows a second embodiment for setting up a network-initiated PoC session;

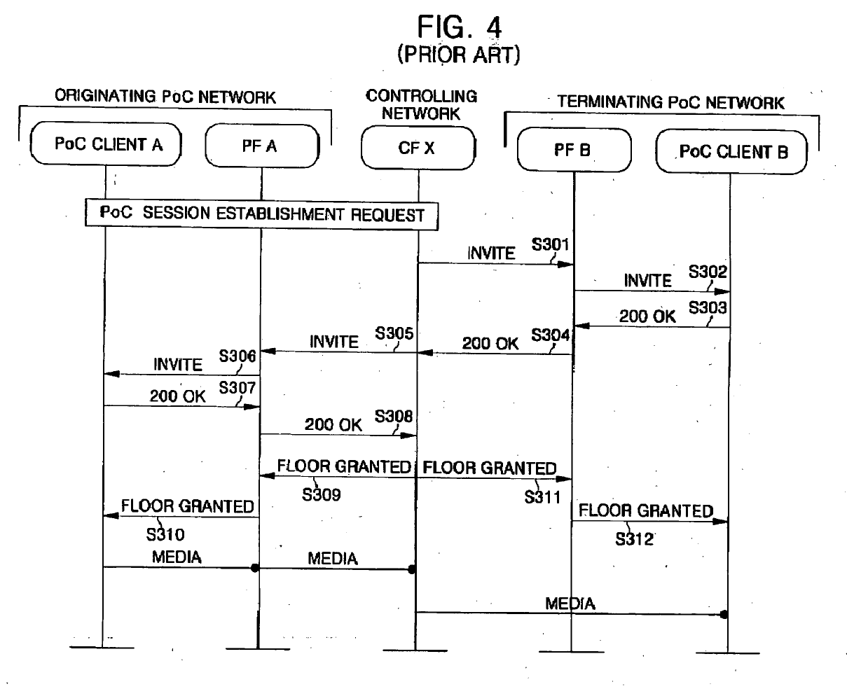

FIG. 5 is a flowchart showing a method for granting the floor using an SIP protocol when a network-initiated PoC session is set up according to the present invention; and

FIG. 6 shows the format of an SIP INVITE message including grant of the floor according to the present invention.

### DETAILED DESCRIPTION OF THE PREFERRED EMBODIMENTS

Hereinafter, preferred embodiments of the present invention will be described in full detail with reference to the accompanying drawings so as enable those skilled in the art to easily implement the present invention.

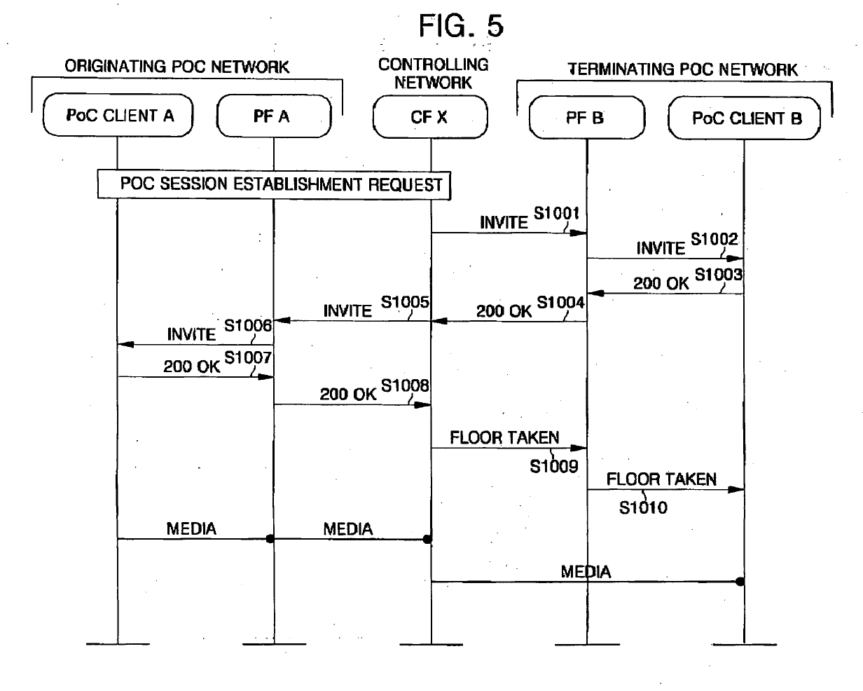

FIG. 5 is a flowchart showing a method for granting the floor to a PoC client that makes a request for a PoC call using a SIP when a PoC session is established in a network.

Referring to FIG. 5, in the state in which a request is made to establish a PoC session based on an event, the CF X of a PoC server which manages an overall system sends a SIP INVITE message to a terminating PoC client B (S1001 and S1002), and receives a 200 OK response according to the approval of a PoC user (S1003 and S1004).

At this time, the terminating PoC client B corresponds to an entity to which a PoC group session is requested by a PoC client A. After receiving the 200 OK response from the PoC client B, the CF X sends the INVITE message for SIP session connection to the PoC client A that requests the session (S1005 and S1006).

Meanwhile, after receiving the 200 OK response signal from the terminating PoC client B (S1003 and S1004), the SIP INVITE message is sent to the PoC client A. Thus, the CF X knows that the terminating PoC client B can receive PoC media.

In other words, after receiving the response signal as in step S1004, the CF X can recognize that the terminating PoC client B can receive the PoC media.

Accordingly, the CF X can grant a first floor of the established session to the PoC client A that requests the PoC call at the beginning in step S1005. To this end, the Floor Granted field of a talk burst control protocol (TBCP) is added to a SDP body in the requested INVITE message, so that invitation to the session and a grant of the floor are possible through one INVITE message. An indicator granting the floor is sent through a content of the body of the SIP INVITE message, and is defined in a field value that expresses media attributes of the TBCP for the PoC session.

Thereafter, when a 200 OK message is sent from the PoC client A to the CF X (S1007 and S1008), the CF X sends the Floor Taken signal of the TBCP, which informs that the floor is granted to another user, to the PoC client B (S1009 and S1010), because the Floor Granted signal has been already sent to the PoC client A using the INVITE message.

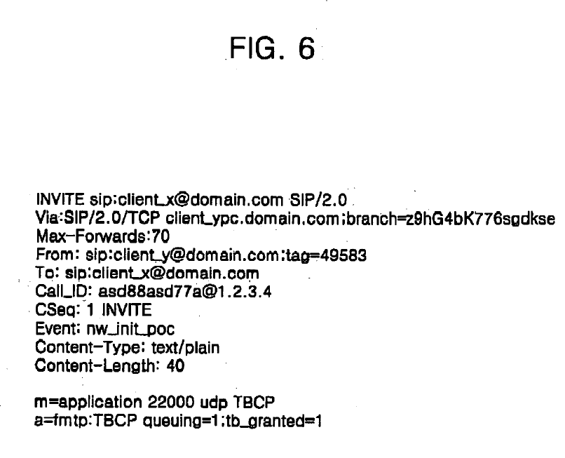

FIG. 6 shows the format of a SIP INVITE message including the grant of the floor according to the present invention.

Referring to FIG. 6, a TBCP attribute value for an OFFER can be inserted into the INVITE message using an m-line (media line) of the TBCP and an a-line (attribute line) that provides the INVITE message with indication of a talk burst control parameter and expression of a media attribute.

The m-line makes use of a template of m=<media><port><transport><fmt list>. In FIG. 6, the template of the m-line indicates that communication of a TBCP signal is performed using “application” as the media, 22000 as the port, and UDP (User Datagram Protocol) as the protocol.

The a-line is for setting up a format parameter of the media. In FIG. 6, the a-line indicates that a queue function is supported, and that the OFFER of granting the floor is sent to the PoC client by the INVITE message.

According to the present invention, with regard to setting up the network-initiated PoC group session, the Floor Granted signal is sent using the SIP instead of the TBCP, so that it is not necessary to send the additional RTCP message.

Further, the Floor Granted signal, which is sent when the 200 OK message is received from the originating PoC client, is sent using the INVITE request message in advance, so that it is possible to rapidly receive the floor.

The method for PoC session establishment and media transmission simply and rapidly implements the procedure of connecting the network-initiated PoC session based on the request of the originating PoC client and the event that is set to the PoC server, so that QoS (Quality of Service) of the PoC service improves, the market related to the PoC service expands, and a savings in expenses required for the PoC terminal and network is realized.

Although exemplary embodiments of the present invention have been described with reference to the attached drawings, the present invention is not limited to these embodiments, and it should be appreciated to those skilled in the art that a variety of modifications and changes can be made without departing from the spirit and scope of the present invention.

What is claimed is:

1. A method for granting a floor in a push-to-talk-over-cellular (PoC) network, the method comprising the steps of:
transmitting a request, by an originating PoC client, to a session management server to set up a session, the request including content related to at least one session initiation requirement;
determining, by the session management server, if the at least one session initiation requirement is met; and
sending, by the session management server, an INVITE message including content related to grant the floor, when the at least one session initiation requirement is met.

2. The method according to claim 1, further comprising sending, by the session management server, a signal informing that the floor is taken.

3. The method according to claim 1, wherein the INVITE message is sent to the originating PoC client.

4. The method according to claim 1, wherein the INVITE message is sent to a participating PoC client.

5. The method according to claim 1, wherein the INVITE message comprises a body including a floor granted field.

6. The method according to claim 5, wherein the floor granted field includes a media line field representing a media attribute of a talk burst control protocol.

7. A push-to-talk-over-cellular (PoC) system comprising:
an originating PoC client;
a terminating PoC client; and
a session management server for receiving a session setup request including content related to at least one session initiation requirement from the originating PoC client, determining if the at least one session initiation requirement is met, and sending an INVITE message including content related to grant the floor when the at least one session initiation requirement is met.

8. The PoC system according to claim 7, wherein the session management server sends a signal informing that the floor is taken.

9. The PoC system according to claim 7, wherein the INVITE message is sent to the originating PoC client.

10. The PoC system according to claim 7, wherein the INVITE message is sent to the terminating PoC client.

11. The PoC system according to claim 7, wherein the INVITE message comprises a body including a floor granted field.

12. The PoC system according to claim 11, wherein the floor granted field includes a media line field representing a media attribute of a talk burst control protocol.

13. A method for granting a floor to a push-to-talk-over-cellular (PoC) client, the method comprising the steps of:
sending session setup request information including content related to at least one session initiation requirement; and
receiving an INVITE message including content related to grant the floor from a session management server.

14. A push-to-talk-over-cellular (PoC) client characterized by sending session setup request information including content related to at least one session initiation requirement, and by receiving an INVITE message including content related to grant a floor from a session management server.
